(19) United States
(12) Patent Application Publication
(10) Pub. No.: US 2024/0128577 A1
(43) Pub. Date: Apr. 18, 2024

(54) Locking Device for Locking a Rechargeable Battery Pack

(71) Applicant: Robert Bosch GmbH, Stuttgart (DE)

(72) Inventors: Simon Buck, St. Johann (DE); Fabian Philipzik, Tuebingen (DE); Peter Kunert, Lichtenstein (DE)

(21) Appl. No.: 18/547,381

(22) PCT Filed: Feb. 8, 2022
(86) PCT No.: PCT/EP2022/052989

§ 371 Date: Aug. 22, 2023

(30) Foreign Application Priority Data
Feb. 26, 2021 (DE) 10 2021 104 614.9

(51) Int. Cl. H01M 50/264; B62J 43/13; B62M 6/90; H01M 50/249

(52) U.S. Cl. CPC H01M 50/264; B62J 43/13; B62M 6/90; H01M 50/249; H01M 2220/20

(57) ABSTRACT

A locking device for locking a rechargeable battery pack with a consumer is disclosed. The locking device includes a rechargeable battery pack interface for releasably connecting the locking device to the rechargeable battery pack along a connecting direction. The rechargeable battery pack interface has a receptacle in which the rechargeable battery pack is at least partially arranged in the connected state, and at least one movably mounted locking element. The locking element is always movable in the unconnected state and/or is preloaded with a force counter to the connecting direction in the connected state.

### PRIOR ART

DE 20 2013 008 187 U1 describes a bicycle frame having an elongate section for receiving a power supply unit.

### DISCLOSURE OF THE INVENTION

The invention relates in particular to a system comprising a rechargeable battery pack and a connecting device, wherein the connecting device is designed for releasably connecting the rechargeable battery pack to a drivable transportation means, wherein the connecting device comprises a locking device designed for locking the rechargeable battery pack to the connecting device, wherein the locking device comprises a rechargeable battery pack for releasably connecting the locking device to the rechargeable battery pack and a consumer interface for connecting the locking device to the electrically drivable transport means, wherein the connecting device comprises a guide device designed for guiding the rechargeable battery pack. It is proposed that the locking device comprise a housing designed to be connectable to the guide device in at least two different configurations. Advantageously, an optimal connection and/or integration between the rechargeable battery pack and the transport means can be achieved as a result.

The connecting device is preferably designed or provided for a one-step locking system. The term “one-step locking system” is in this context intended to mean that unlocking is possible via a single actuation by the user, e.g., a button press or unlocking process. However, it is also conceivable that the connecting device be designed or provided for a two-step locking system. A two-step locking system is in this context intended to mean that unlocking is only possible via two or at least two separate operations by the user, e.g., an opening process as a first actuation and actuation of a further button as a second actuation. Advantageously, a two- or multi-step locking system can ensure that the user is always in control of the rechargeable battery pack.

The rechargeable battery pack comprises a rechargeable battery pack housing, in which at least one battery cell is arranged. A battery cell can be designed as a galvanic cell which has a structure in which one cell pole comes to lie at one end and a further cell pole comes to lie at an opposite end. The battery cell in particular comprises a positive cell pole at one end and a negative cell pole at an opposite end. Preferably, the battery cells are as NiCd or NiMh, particularly preferably as lithium-based battery cells or Li-ion battery cells. The battery voltage of the rechargeable battery pack is typically a multiple of the voltage of a single battery cell and results from the circuit (parallel or serial) of the battery cells. It is also conceivable that the battery cells be designed as prismatic cells or pouch cells. In common battery cells with a cell voltage of 3.6 V, voltage classes of, e.g., 3.6 V, 7.2 V, 10.8 V, 14.4 V, 18 V, 36 V, 54 V, 108 V etc., are produced. A battery cell is preferably designed as an at least substantially cylindrical round cell, wherein the cell poles are arranged at the ends of the cylindrical shape. The rechargeable battery pack housing is in particular designed as an outer housing. The rechargeable battery pack housing can comprise one or more housing parts. The housing parts are connected to each other in a positive, positive and/or material manner. The battery pack is preferably designed as a rechargeable battery pack. The rechargeable battery pack is preferably designed as an integrated battery pack partially or entirely arranged in a housing or within a frame of the transportation means when connected to the transportation means. Alternatively, it is also conceivable that the rechargeable battery pack be designed such that the rechargeable battery pack is attachable to the exterior of the housing or frame of the transportation means.

The connecting device is in particular designed to detachably connect the rechargeable battery pack to the housing or frame of the transportation means. The connecting device can be partially or entirely arranged in the housing or frame of the transportation means. However, it is also conceivable that the connecting device, in particular the locking device, be partially or entirely arranged on an outer side of the housing or frame of the transportation means.

The electrically drivable transportation means is preferably designed as an electric bicycle. Alternatively, it is likewise conceivable that the transportation means be designed as an electric scooter, an electric cart, a wheelchair, a golf cart, a Segway, or the like. The transportation means comprises a power unit with an electric motor, wherein the rechargeable battery pack, when connected, supplies power to the electric motor. The transportation means comprises at least one wheel, preferably at least two wheels, wherein a drive movement of the electric motor is transferred to at least one wheel. The transportation means comprises a control unit designed to control and/or regulate the transportation means, particularly the power unit. In addition, the transportation means preferably comprises an HMI (human machine device), wherein the HMI comprises a display unit for displaying information and a control unit for adjusting the HMI and/or the transportation means. The HMI is in particular designed as a charge state indicator, via which a charge state of the rechargeable battery pack in the connected and/or unconnected state can be indicated. The transportation means designed as an electric bicycle comprises a frame. Sensors, the control unit, the power unit, the connecting device, and/or the rechargeable battery pack can be arranged in whole or in part within the frame. The housing or frame of the transportation means preferably consists mostly or entirely of metal and/or a fiber-reinforced plastic.

The rechargeable battery pack interface is preferably designed such that the rechargeable battery pack is connectable to the locking device via linear movement and/or rotational movement relative to one another. Advantageously, the rechargeable battery pack can thus be connected to the transportation means via both a sliding movement and a pivoting movement.

The guide device is preferably designed as a linear guide device, wherein the rechargeable battery pack has a single linear degree of freedom in the connected state relative to the guide device, but not relative to the locking device. The guide device preferably comprises at least one guide rail and/or at least one guide groove connectable to a corresponding guide groove and/or guide rail of the rechargeable battery pack. In an alternative embodiment of the invention, it is also conceivable that the consumer interface or connecting device not comprise a guide device.

The housing of the locking device can be made of a plastic and/or a metal. The housing can have a one-part or multi-part design. In the context of this application, the term “one-part” is in particular intended to mean individual components or several components connected to one another in a bonded manner. The housing of the locking device is preferably designed in two parts, in wherein the first housing part is connected to the second housing part via a frictional and/or interlocking connection, in particular via a latching connection. The rechargeable battery pack interface is partially or entirely arranged within the housing of the locking device. Preferably, the movable components of the rechargeable battery pack interface are supported within the housing of the locking device. The housing comprises an opening designed to receive the rechargeable battery pack. The locking device can be connected to the guide device via a bonded connection or via a frictional and/or interlocking connection.

In the context of this application, the phrase “at least two different configurations” is intended in particular to mean that the guide device is connectable to the locking device housing at two different locations on the latter. Advantageously, doing so changes the relative arrangement of the rechargeable battery pack interface relative to the guide device, which provides additional options for integration into the transportation means or the design and arrangement of the rechargeable battery pack.

It is further proposed that the housing of the locking device comprise a first side having at least one first connecting element designed for connecting the locking device to the guide device, and a second side having at least one second connecting element for connecting the locking device to the guide device. Advantageously, the same housing can be employed for different configurations by means of this measure. The housing can comprise several first connecting elements designed to be substantially the same or different. In addition, the housing can comprise several second connecting elements designed to be substantially the same or different. In particular, the first side connecting elements differ from the second side connecting elements substantially not in the design, but only in the positioning on the housing of the locking device. The first side and the second side are in particular designed as outer sides. Preferably, the housing is designed such that only the first side or only the second side is connectable to the guide device.

It is further suggested that, when viewed along a connecting direction of the rechargeable battery pack, the at least one connecting element of the second side is arranged to be rotated by an angle X relative to the at least one connecting element of the first side. The angle X is preferably substantially 30°, 60°, 90°, or a multiple of these values. Advantageously, an optimum arrangement can thereby be achieved.

It is further proposed that the first side and the second side of the housing of the locking device be at a distance from one another, in particular adjacent one another. Preferably, the first side and the second side of the housing have a common edge. The common edge can extend in a straight or curved manner.

It is further proposed that the rechargeable battery pack interface be arranged at least partially within the housing of the locking device.

It is further proposed that the battery pack comprise a rechargeable battery pack housing, wherein the rechargeable battery pack housing is connected to at least one adapter element. Advantageously, the rechargeable battery pack housing can be adapted to the configuration of the locking device by way of the adapter element. The adapter element can be designed to be in one piece or integral with the rechargeable battery pack housing. In the context of this application, the term “integral” is intended to mean an individual component not consisting of components connected in a bonded and frictional manner and/or to one another in a frictional manner. The adapter element is preferably connected to the rechargeable battery pack housing in a frictional and/or interlocking manner. Preferably, the connection is made via a screw connection. The adapter element can, e.g., be made of a plastic and/or a metal. In particular, the adapter element is designed as a hybrid component that comprises, e.g., a plastic part with a sheet metal insert. It is further conceivable that the adapter element comprise a metallic rail and a connecting element made of plastic. The adapter element can be designed to be connectable to the rechargeable battery pack in various orientations relative to the battery cells. It is also conceivable that the adapter element be provided for a specific configuration of the locking device and that a further adapter element be provided for a further configuration.

It is further proposed that the adapter element comprise a guide unit designed such that the adapter element can be arranged to engage with the guide device in order to axially guide the battery pack when connecting the rechargeable battery pack. Advantageously, an optimal connection between the rechargeable battery pack and the transportation means can thereby be provided. The guide unit is preferably in one piece or integrally connected to the adapter element. In particular, the adapter element comprises at least one guide groove, which corresponds to a guide rail of the guide device. Preferably, the rechargeable battery pack comprises two adapter elements mounted on the front faces of the rechargeable battery pack housing.

It is further proposed that the adapter element comprise a connection unit for connection to the locking device, in particular to the rechargeable battery pack interface of the locking device, in order to axially fix the rechargeable battery pack. Advantageously, the position of the connecting unit can thereby be adapted to the configuration.

It is further proposed that the system comprise a further adapter element for alternative connection to the rechargeable battery pack, wherein the further adapter element comprises a guide unit and a connection unit, which are twisted at an angle X relative to the guide unit and the connection unit of the adapter element. Advantageously, the further adapter element can thereby be optimally adapted to a second configuration.

It is also proposed that the guide device be connectable to a housing, in particular a frame, of the transportation means. The connection can be made in a bonded, frictional, and/or interlocking manner. Preferably, the connection is made via a screw connection.

It is further proposed that the locking device be connected to the guide device via a two-step process, wherein in a first step, a first relative movement of the locking device relative to the guide device occurs and, in a second step, a second relative movement of the locking device relative to the guide direction occurs, wherein the first relative movement crosses the second relative movement. The relative movements can be translational and/or rotational relative movements. Advantageously, screws or the like can be omitted, thereby making a space-saving and light design achievable.

The invention relates to a locking device for locking a rechargeable battery pack with a consumer, comprising a rechargeable battery pack interface for releasably connecting the locking device to the rechargeable battery pack along a connecting direction, wherein the rechargeable battery pack interface has a receptacle, in which the rechargeable battery pack is at least partially arranged in the connected state, and at least one movably mounted locking element. The invention proposes that the locking element is always movable in the unconnected state and/or is preloaded with a force counter to the connecting direction in the connected state. Advantageously, the joining process can thereby be optimized for the user.

The consumer is preferably designed as an electrically drivable transportation means, preferably an electric bicycle. The locking device is preferably associated with the consumer. However, it would also be conceivable that the locking device be associated with the rechargeable battery pack.

The movably supported locking element can be made of a plastic and/or a metal. The locking element can be regionally reinforced, e.g. by metallic inserts, in order to counteract wear. The locking device can comprise one or more locking elements. The movably supported locking element is designed in particular to axially fix the rechargeable battery pack in the connected state. In the fixed state, the rechargeable battery pack is preferably held directly by the locking element. As a result, the locking element touches the rechargeable battery pack in the fixed state. In the fixed state, the rechargeable battery pack is in particular connected substantially without clearance. Preferably, the rechargeable battery pack is held in the fixed state by the locking element. It is further conceivable that the locking element comprise a damping element, e.g. a rubber buffer.

In this context, the term “always movable” is intended to mean that the locking element is not fixed or fixable in the unconnected state. It can as a result be ensured that a connection between the rechargeable battery pack and the consumer is always possible.

The force with which the locking element is preloaded counter to the connecting direction in the connected state or the fixed state is preferably designed such that the locking element is, by its own action, pushed out of the receptacle when the fixation of the rechargeable battery pack is released, i.e., without being pulled by the user. The length of the path that the rechargeable battery pack is moved by said force in this case preferably corresponds to at least half the length of the receptacle along the connecting direction.

It is also proposed that the locking element be pivotally supported about a locking axis. Alternatively or additionally, it would also be conceivable that the locking element be designed to be linearly movable.

It is further proposed that the locking element be acted upon by a force counter to the direction of connection by means of at least one first reset element. The reset element is preferably designed as a spring element. For example, the spring element can be designed as a ring spring, a spiral spring, a leg spring, etc. The spring element can be made of a plastic and/or a metal.

It is further proposed that the first reset element be directly connected to the locking element. In particular, the reset element is movably or rigidly connected to the locking element.

It is also proposed that the locking device comprise a movably supported blocking element, wherein the blocking element is designed to block the locking element in at least one state. Advantageously, a secure fixation of the locking element can be achieved by the blocking element. The blocking element is designed such that in the blocking element blocks the locking element in the fixed state, in which the blocking element is in particular preloaded. In particular, in the fixed state the blocking element directly borders the locking element such that the blocking element contacts the locking element.

It is further proposed that the blocking element be pivotally supported about a blocking axis. The blocking axis is preferably designed to be parallel to the locking axis. Alternatively, it would also be conceivable that the blocking axis and the locking axis be designed to cross one another or be oriented at 90° to one another. It would also be conceivable for the blocking element to be linearly movable.

It is further proposed that the blocking element be acted upon by a force in the direction of the locking element by means of at least a second reset element. The second reset element is preferably designed as a spring element. For example, the spring element can be designed as a ring spring, a spiral spring, a leg spring, etc. The spring element can be made of a plastic and/or a metal.

It is also proposed that the locking device comprise a movably mounted release element, wherein the release element is designed to be manually actuatable, wherein the release element is designed to move the blocking element from a blocking position to a release position. Fixation of the rechargeable battery pack by means of the locking element is possible in the blocking position of the blocking element. In the release position of the blocking element, fixation of the rechargeable battery pack is not possible, or the fixation is released and the rechargeable battery pack is at least partially pushed out of the receptacle. The release element and the blocking element are preferably movable relative to each other.

It is further proposed that the blocking element be acted upon by a force by means of the second reset element such that the release element is moved to a home position in the unactuated state. Advantageously, it can thereby be ensured that the locking element is always movable in the unfixed state. Alternatively or additionally, it is likewise conceivable that the locking device comprise an additional reset element provided for automatically returning the release element to the home position. Preferably, the reset element is designed such that the reset element always borders the blocking element.

It is further proposed that the reset element be designed to move the locking element to an unlocking position upon actuation of the release element, wherein the rechargeable battery pack is partially (preferably entirely) pushed out of the receptacle in the unlocked position. Advantageously, the rechargeable battery pack can be easily removed as a result.

It is further proposed that the reset element be designed such that the rechargeable battery pack is always set to the same unlocking position. By way of example, the housing of the locking device can comprise a stop, which the locking element borders in the unlocked state, thus blocking the ejection movement of the rechargeable battery pack by means of the locking element.

It is further proposed that the locking element comprise an actuation region, wherein the actuation region is able to be acted upon in the unlocked state by the rechargeable battery pack and borders the blocking element in the locked state such that movement of the locking element in at least one direction is blocked. Preferably, the movement of the locking element in the blocked or fixed state in both directions is blocked.

It is further proposed that the locking element be designed such that the locking element comprises a fixation region, wherein the fixation region is arranged adjacent the actuation region, wherein the locking element is designed such that the rechargeable battery pack is guided from the actuation region into the fixation region during the connection process. The actuation region and the fixation region are designed to be adjacent to each other. In particular, the actuation region directly transitions into the fixation region such that the rechargeable battery pack borders both regions during the transition. The actuation region is preferably designed as a flat surface. The actuation region is designed to be acted upon by an actuating element or connecting element of the rechargeable battery pack. In this case, the actuation region is in particular the first and last region that the rechargeable battery pack borders during the connection process. The fixation region can be designed as a flat surface or as a curved surface. Preferably, the shape of the fixation region is adapted to a shape of the battery pack, in particular the actuating element of the rechargeable battery pack.

The invention further relates in particular to a locking device for locking a rechargeable battery pack with a consumer, comprising a housing having a rechargeable battery pack interface for releasably connecting the locking device to the rechargeable battery pack along a connecting direction, wherein the rechargeable battery pack interface comprises at least one movably mounted locking element and a movably mounted blocking element, wherein the blocking element is designed to block the locking element in at least one state. It is proposed that the blocking element comprise at least two, in particular three, points of application, where a force can be applied to the blocking element in order to unlock the locking element. Advantageously, the fixation of the rechargeable battery pack can thereby be released in a variety of ways.

The blocking element can have an integral, one-piece, or multi-piece design. The points of application are in particular designed as regions on an outer surface of the blocking element. The points of application are arranged at a distance from one another. The points of application are preferably arranged at end regions of the blocking element relative to the blocking axis of the blocking element in order to create as much leverage as possible. In particular, the blocking element comprises at least two points of application, the distance between which is greater than the distance between the farthest point of application and the blocking axis.

It is further proposed that the locking device comprise a movably mounted release element, wherein the release element is designed to be manually actuatable, wherein the release element is designed to move the blocking element from a blocking position to a release position. The release element can be directly manually or indirectly manually actuatable. In the context of this application, the term “release element” is in particular intended to mean a release element that is mechanically connected to an actuating button so that a force for actuating the release element is exerted by the user. The force can in this case be directly applied to release element or via one or more mechanically connected components. In the context of this application, the term “indirectly, manually actuatable release element” is in particular intended to mean a release element that is mechanically connected to an actuator. The actuator can be mechanical, electromechanical, or magnetic, etc. The actuator can, e.g., be controllable by means of an operating button. The operating button can be connected to an electronic switch. It is also conceivable that the actuator be controllable via a computing device, e.g., a smartphone or a smartwatch, or via an RFID transmitter.

It is further proposed that the release element be connected or coupled to a lock assembly. The lock assembly can be designed as a mechanical lock, wherein the lock is operable using an associated key, and the release element connected to the mechanical lock is movable. Alternatively, the lock unit can be designed as an electronic lock. For example, the electronic lock can comprise a communication interface, by means of which data is wirelessly transferable via Bluetooth, Wi-Fi, a cellular network, RFID, or the like. The electronic lock can thus be controlled, in particular unlocked and/or closed, via an external computing device. Alternatively or additionally, it is also conceivable that the electronic lock comprise a fingerprint sensor, a face detection means, or the ability to enter an unlock code.

It is further proposed that the locking device comprise a housing, in which the lock unit is arrangeable in a first orientation or in a second orientation. Advantageously, the lock unit can thereby be positioned partially independent of the configuration of the locking device.

It is further proposed that the blocking element be designed to be acted upon at different points of application by the release element, which is connected to the lock unit in the first orientation and in the second orientation. Advantageously, optimum actuation of the blocking element can thereby always be achieved.

It is also proposed that the points of application be arranged at a distance from one another. In particular, the points of application are arranged at different levels. In this case, these planes extend orthogonally to the blocking axis and/or the locking axis.

It is further proposed that the lock unit in the first orientation be substantially directly connected to the housing and, in the second orientation, via an adapter housing connected to the housing of the locking device. Advantageously, a secure arrangement of the lock unit can thereby be achieved. The adapter housing is inserted into the housing of the locking device during the assembly process. The adapter housing is preferably connected to the housing of the locking device in a frictional and/or interlocking manner.

It is further proposed that the locking device in the second orientation comprise a transfer element that transfers a movement of the release element to the blocking element. In particular, the transfer element is designed such that a rotational movement of the release element about a release axis is converted into a rotational movement of the blocking element about a blocking axis, wherein the release axis is arranged in a crossing manner, in particular substantially perpendicular to the blocking axis. Alternatively, it is also conceivable that a rotational movement of the release element be converted into a linear movement of the blocking element.

It is also proposed that the first point of application be arranged on a side of the blocking element opposite the second and/or third point(s) of application. Advantageously, another option for actuating the blocking element can be provided by the additional point of application. The lock is in particular designed such that the blocking element in a first orientation of the lock unit comprises the first and the second points of application and, in a second orientation of the lock unit, comprises the first point of application and the third point of application. Accordingly, the locking device comprises a point of application that is dependent on the orientation of the lock unit, and a point of application that is independent of the orientation of the lock unit.

It is further proposed that the first point of application be arranged adjacent to a recess in the housing of the locking device. The first point of application can be designed to be actuatable via a further lock unit. For example, the locking device can thus comprise a mechanical lock and an electronic lock. Preferably, the first point of application is designed to be actuatable via a tool, e.g., via a pin used by a user in order to apply a force to the blocking element. Advantageously, the lock unit can thereby be omitted in order to provide a particularly favorable and lightweight embodiment.

It is further proposed that the locking device be arranged in a frame of the electric bicycle, wherein the lock unit comprises a first operating region which can be arranged laterally on the frame in both the first orientation and the second orientation. Advantageously, convenient lateral operation can always be guaranteed for the user regardless of the installation of the connecting device. The first operating region is designed to be accessible and actuatable by the user from the outside.

It is further proposed that the frame comprise a recess that is arranged adjacent the recess of the housing of the locking device and forms a second operating region. In particular, a channel for a tool is formed by the recess in the frame and the recess in the housing of the locking device. Advantageously, an additional option for actuating the blocking element can thereby be provided. The actuation of the blocking element via the first operating region is in this case performed by the release element, whereas the actuation of the blocking element is performed by the second operating region, without the release element.

It is further proposed that the first operating region and the second operating region be arranged opposite one another or offset by 90° from one another. A particularly advantageous arrangement of the operating regions can be achieved by means of this measure.

### DRAWINGS

Further advantages will become apparent from the following description of the drawings. The drawings, the description, and the claims contain numerous features in combination. The skilled person will appropriately also consider the features individually and combine them into further meaningful combinations. Alternative embodiments or components are described using the same reference number and an additional letter.

### Shown are:

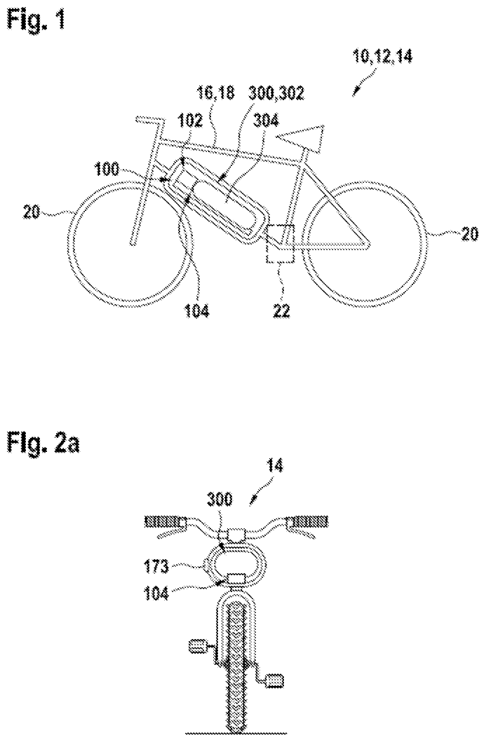

FIG. 1 a schematic view of a moving means with a connecting device according to the invention;

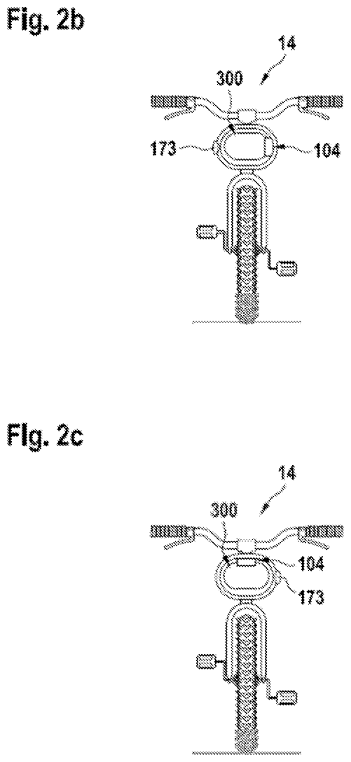

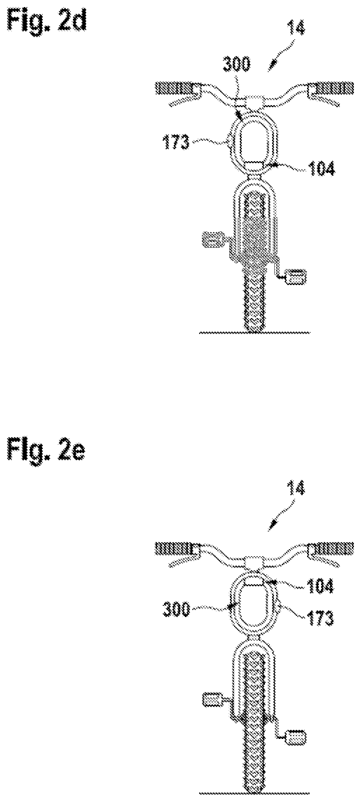

FIGS. 2 a-e schematic views of various arrangements and configurations of the connecting device according to the invention;

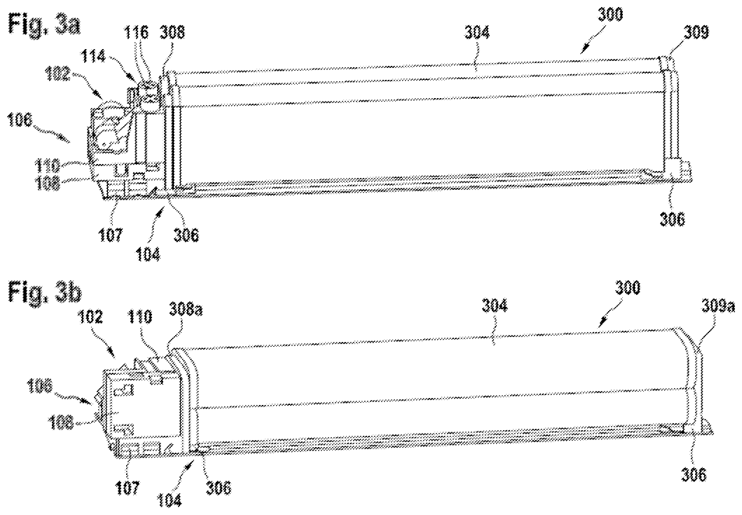

FIG. 3a a perspective view of the connecting device in a first configuration;

FIG. 3b a perspective view of the connecting device in a second configuration;

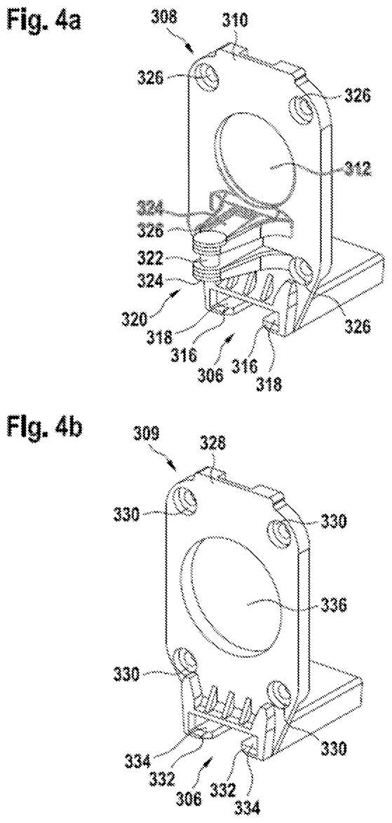

FIG. 4a,b a perspective view of an adapter element for the first configuration;

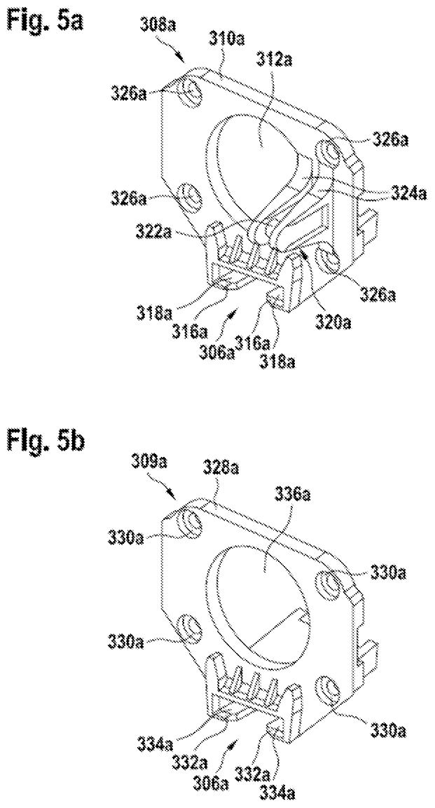

FIG. 5a,b a perspective view of an adapter element for the second configuration;

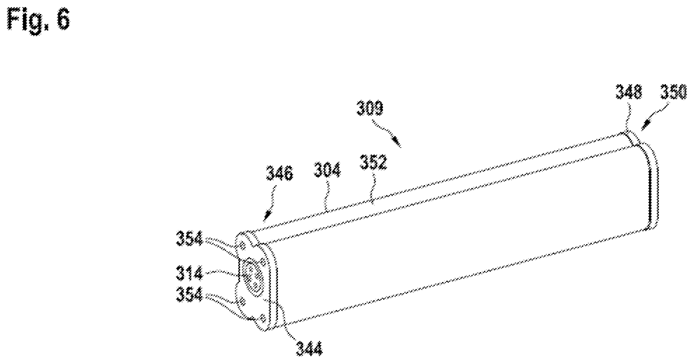

FIG. 6 a perspective view of a rechargeable battery pack for the connecting device;

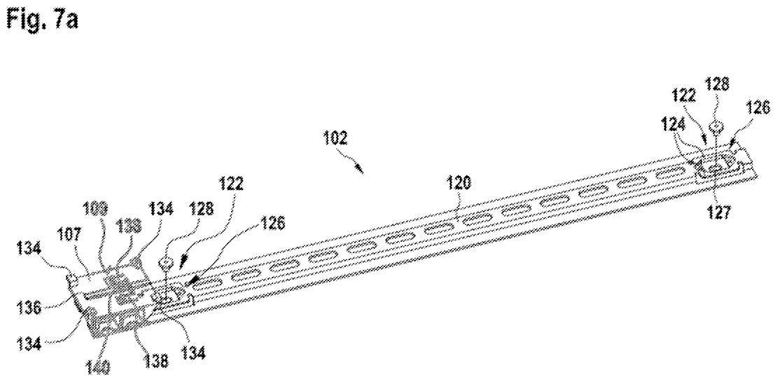

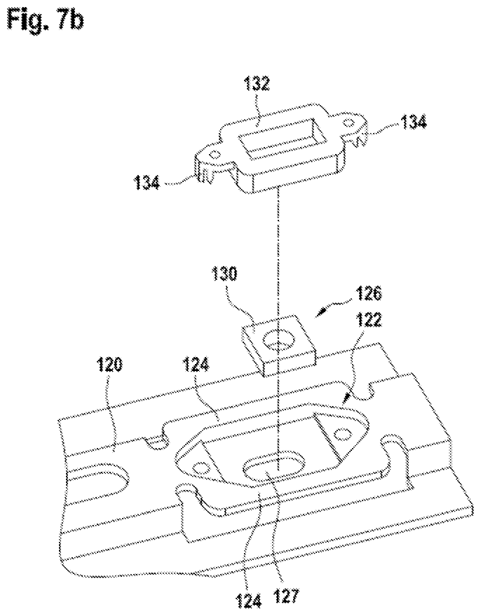

FIG. 7a,b a perspective view of a guide device of the connecting device;

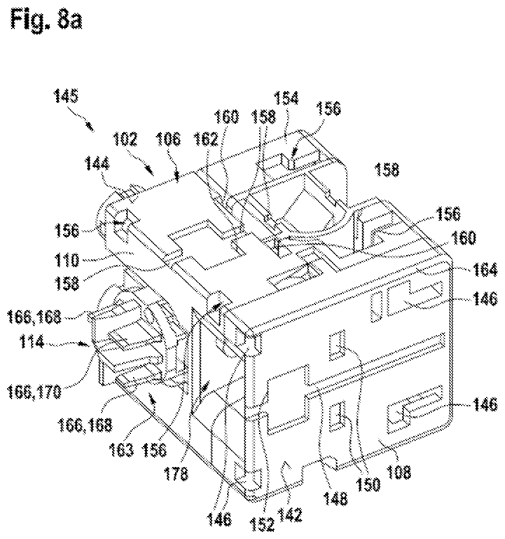

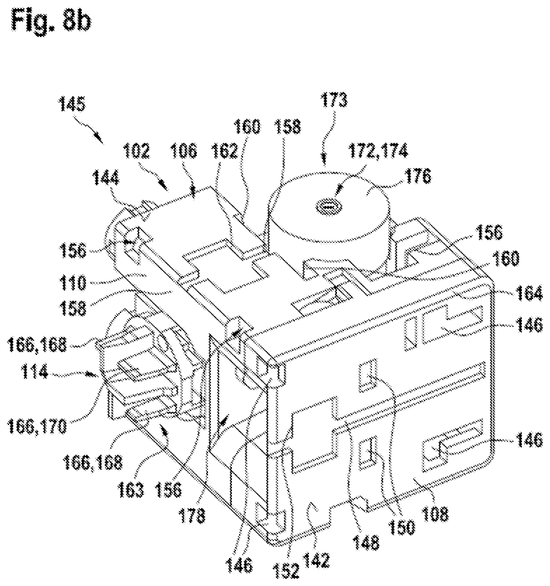

FIG. 8a a perspective view of a locking device of the connecting device with an adapter housing;

FIG. 8b a perspective view of a locking device of the connecting device without the adapter housing;

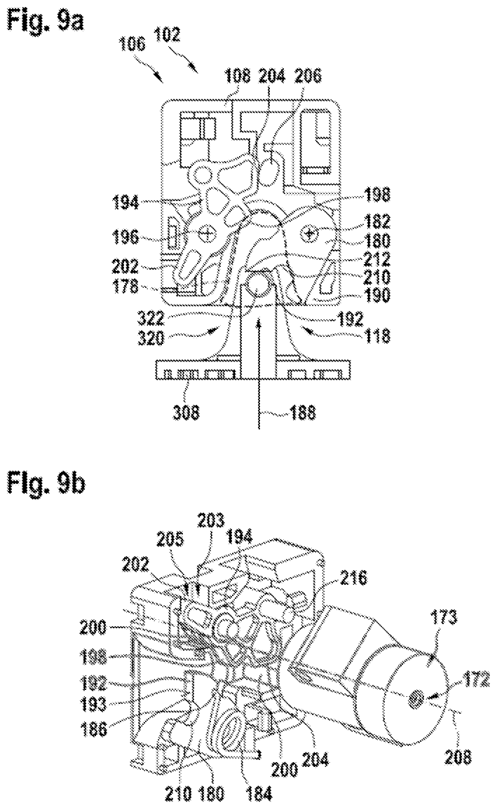

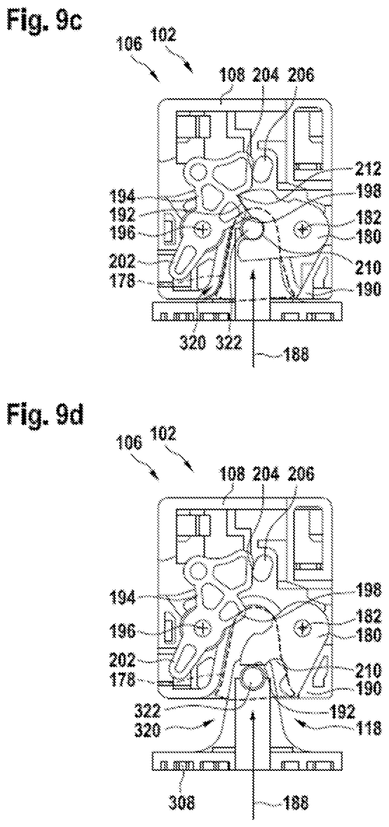

FIG. 9a an overhead view of the locking device in the second configuration in the unconnected state;

FIG. 9b a partial perspective view of the locking device in the second configuration in the unconnected state;

FIG. 9c an overhead view of the locking device in the second configuration in the locked or fixed state;

FIG. 9d an overhead view of the locking device in the second configuration in the unlocked state;

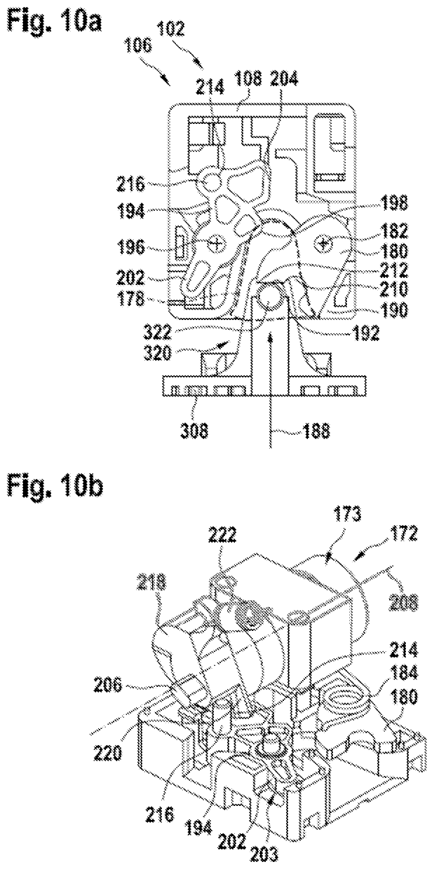

FIG. 10a an overhead view of the locking device in the first configuration in the unconnected state;

FIG. 10b a partial perspective view of the locking device in the first configuration in the unconnected state.

In FIG. 1, a consumer 10 with a connecting device 100 according to the invention is shown in a schematic side view. The consumer is designed as an electrically driven transportation means 12, particularly as an electric bicycle 14. For example, the electric bicycle 14 can be designed as a pedelec or as an e-bike.

The consumer 10 comprises a housing 16 in the form of a frame 18, or rather a bicycle frame. Two wheels 20 are connected to the frame 18. The consumer 10 also comprises a power unit 22 having an electric motor or auxiliary motor. The electric motor is preferably designed as a permanent magnet-energized, brushless DC motor. The electric motor is, e.g., designed as a central motor, wherein a hub motor or the like also is conceivable.

The power unit 22 comprises a control unit (not shown) designed to control or regulate the electric bicycle 14, in particular the electric motor. The electric bicycle 14 comprises a pedal crank (not shown). The pedal crank comprises a pedal crankshaft (not shown).

The control unit and the drive unit 22 having the electric motor and the pedal crankshaft are arranged in a drive housing (not shown) connected to the frame. The drive motion of the electric motor is preferably transferred to the crankshaft via a transmission (not shown), wherein the magnitude of assistance is controlled or regulated by the power unit 22 via the control unit.

The consumer 10 is electrically and mechanically connected to a rechargeable battery pack 300 designed to provide the power unit 22 with energy. The connection is made via the connecting device 100. The rechargeable battery pack 300 is designed as an interchangeable, rechargeable battery pack 302. The frame 18 comprises an opening (not shown), through which the rechargeable battery pack 300 can be pushed or pivoted into the frame 18. The opening is closed in the connected state by a rechargeable battery pack housing 304. Alternatively, it is also conceivable that the frame 18 itself close the opening or be enclosed by a cover.

The connecting device 100 comprises a locking device 102 designed to lock the rechargeable battery pack 300 to the connecting device 100. The connecting device 100 further comprises a guide device 104 designed to guide the rechargeable battery pack 300 during the connection with the electric bicycle 14. The locking device 102 and the guide device 104 are, e.g., completely arranged within the frame 18 of the electric bicycle 14.

The connecting device 100 is modularly designed so that the rechargeable battery pack 300 is connectable to the electric bicycle 14 in different orientations. In FIGS. 2a-c, the rechargeable battery pack 300 is received in a horizontal orientation in the frame 18, wherein the guide device 104 can be arranged at different locations on the frame 18 due to the modular construction. The electric bicycles 14 in FIGS. 2 a-c can be three different electric bicycles or the same electric bicycle 14, wherein if the electric bicycle 14 is the same, then the connecting device 100 must be reinstalled.

In FIGS. 2 d-e, the rechargeable battery pack 300 is received in a vertical orientation in the frame 18, wherein the guide device 104 can be arranged in a different location on the frame 18a due to the modular construction. The electric bicycles 14a in FIGS. 2 d-e can be two different electric bicycles or the same electric bicycle 14a, wherein if the electric bicycle 14a is the same, then the connecting device 100 must be reinstalled. The electric bicycle 14 according to FIGS. 2 a-c differs from the electric bicycle 14a by a geometry of the frame 18a.

The connecting device 100 comprising a connected rechargeable battery pack 300 is shown in a perspective view in FIG. 3a. The connecting device 100 is modular in that both the rechargeable battery pack 300 and the locking device 102 can be arranged in different orientations or configurations relative to the guide device 104. In FIG. 3a, rechargeable battery pack 300 is arranged in a vertical position. The connecting device 100 and the rechargeable battery pack 300 shown in FIG. 3a are installed, e.g., in the electric bicycles 14 shown in FIGS. 2 d-e.

The locking device 102 comprises a housing 106 connected to the guide device 104, in particular a mounting module 107 of the guide device 104. The housing 106 of the locking device 102 is, e.g., made of a plastic. The housing 106 of the locking device 102 has, e.g., a two-part design, wherein a first housing portion 108 is connected to a second housing portion 110 in a frictional and interlocking manner. In the vertical position, only the second housing portion 110 is connected to the mounting module 107 in a frictional and/or interlocking manner.

The locking device 102 comprises a plug unit 114 having at least one, e.g. two, connectors 116 for connection to plugs (not shown). The rechargeable battery pack 300 can be connected to the control unit of the electric bicycle 14 and/or a charging port (not shown) via the plug unit 114. The rechargeable battery pack 300 is designed to be rechargeable via the charging port when connected to the electric bicycle 14. The plug unit 114 is received in the housing 106 of the locking device 102. In particular, the plug unit 114 is flexibly mounted in the housing 106. In particular, the plug unit 114 is supported in the housing 106 such that the plug unit 114 is movable perpendicular to the insertion direction. Advantageously, it can be ensured that no forces are transferred after insertion from the plug unit 114.

The rechargeable battery pack 300 is connected or axially fixed to the locking device 102 via a rechargeable battery pack interface 118 (see FIG. 9a). In addition, the rechargeable battery pack 300 comprises a guide unit 306 designed corresponding to the guide device 104 of the connecting device 100. The guide unit 306 is associated with a first adapter element 308 and a second adapter element 309 that are connected to the front side of the rechargeable battery pack 300, in particular the rechargeable battery pack housing 304. The connection is made, e.g., by way of a screw connection. The first adapter element 308 is arranged on a side of the rechargeable battery pack 300 facing the locking device 102. The second adapter element 309 is arranged on a side of the rechargeable battery pack 300 facing away from the locking device 102. More particularly, the distance between the first adapter element 308 and the second adapter element 309 and the respective guide units 306 substantially corresponds to the length of the rechargeable battery pack 300.

In FIG. 3b, the connecting device 100 comprising a rechargeable battery pack 300 is shown in a perspective view, wherein the rechargeable battery pack 300 is arranged in a horizontal position. The connecting device 100 and the rechargeable battery pack 300 shown in FIG. 3b are, e.g., installed in the electric bicycle 14 shown in FIG. 2a. The locking device 102 shown in FIG. 3a and FIG. 3b can be the same or equivalent.

In the horizontal position, the first housing portion 108 and the second housing portion 110 are connected to the mounting module 107 in a frictional and/or interlocking manner.

The rechargeable battery pack 300 shown in FIG. 3a and the rechargeable battery pack 300 shown in FIG. 3b are substantially identical and differ in particular only by the adapter elements 308a, 309a. Accordingly, the rechargeable battery pack 300 having the same rechargeable battery pack housing 304 can be adjusted to a horizontal or vertical position by the selection of adapter elements 308a, 309a.

The overall system in the vertical orientation (FIG. 3a) thus has a greater height and a smaller width than the overall system in the horizontal orientation (FIG. 3b).

In FIG. 4a, the first adapter element 308 is shown in a perspective view. The first adapter element 308 is, e.g., designed to be integral. The first adapter element 308 comprises a base body 310 having, e.g., a cylindrical recess 312 provided for connecting the plug unit 114 of the connecting device 100 to a corresponding plug 314 of the rechargeable battery pack 300.

The guide unit 306 of the adapter element 308 comprises a pair of guide rails 316 arranged adjacent to a pair of guide grooves 318. The two guide rails 316 are, e.g., oriented inwards, but it would alternatively or additionally also be conceivable for the guide rails 316 to be oriented outwards. The guide unit 306 is in particular designed to receive a T-shaped guide rail. The guide unit 306 extends substantially linearly in a first direction starting from the recess 312.

The first adapter element 308 further comprises a connection unit 320 designed to connect the rechargeable battery pack 300 to the locking device 102. Starting from the recess 312, the connecting unit 320 extends in a second direction counter to the first direction. The connecting unit 320 comprises a connecting element 322 designed, e.g., to be substantially cylindrical. The connecting element 322 is connected to the base body 310 via two arms 324 arranged on the front side.

The base body 310 further comprises four screw bosses 326 provided for screwing the adapter element 308 to the rechargeable battery pack housing 304.

In FIG. 4b, the second adapter element 309 is shown in a perspective view. The second adapter element 309 substantially corresponds to the first adapter element 308, wherein the second adapter element 309 has no connecting unit. The second adapter element 309 comprises a base body 328 having four screw bosses 330 and a pair of guide rails 332 arranged adjacent a pair of guide grooves 334. The base body 328 further comprises a recess 336, which is designed to be larger than the recess 312 of the first adapter element 308. The recess 336 is particularly provided for a valve of the rechargeable battery pack 300 (not shown). The second adapter element 309 is, e.g., designed to be integral.

In FIG. 5a, the first adapter element 308a for horizontal orientation is shown in a perspective view.

The first adapter element 308a for the horizontal orientation and the first adapter element 308 for the vertical orientation comprise substantially the same functional and technical features. The first adapter element 308a for the horizontal orientation differs in particular by the relative positioning of the connection unit 320a relative to the guide unit 306a, which is rotated by a 90° angle compared to the first adapter element 308 for the vertical orientation. The positioning of the screw boss 326 is likewise, e.g., rotated by 90°.

In FIG. 5b, the second adapter element 309a for the horizontal orientation is shown in a perspective view. The second adapter element 309a comprises substantially the same functional and technical characteristics as the second adapter element 309 for the vertical orientation. The only difference is the optionally different arrangement of the screw boss 330a and the associated change to the base body 328a.

A perspective view of the rechargeable battery pack 300 is shown in FIG. 6. For example, the rechargeable battery pack 300 comprises 20 battery cells (not shown) arranged in a cell holder (not shown). The cell holder is, e.g., arranged entirely within the rechargeable battery pack housing 304. However, it is also conceivable that the cell holder form part or all of the rechargeable battery pack housing 304. The rechargeable battery pack housing 304 is designed as an outer housing. The rechargeable battery pack 300 is thus, e.g., designed as a 36 V rechargeable battery pack with a capacity of 400 Wh.

Also arranged in the rechargeable battery pack housing 304 is circuitry (not shown) comprising a circuit board (not shown). This circuitry comprises a BMS (battery management system) designed to control and/or regulate the rechargeable battery pack 300. The circuit board is connected to the battery cells in order to monitor the individual cell voltages.

The rechargeable battery pack housing 304 comprises a first end plate 344 that closes an aperture on a plug side 346 and a second end plate 348 that closes an aperture on a valve side 350. The end plates 344, 348 are connected to a base body 352 of the rechargeable battery pack housing 304. The base body 352 of the rechargeable battery pack housing 304 has a substantially hollow cylindrical shape, which is adapted to the battery cells or the cell holder.

The circuitry of the rechargeable battery pack 300 is connected to a plug 314 for electrical contact.

The end plates 344, 348 comprise interlocking points and screw points 354, via which the adapter elements 308, 308a, 309, 309a are connectable to the end plates 344, 348.

In FIG. 7a, the guide device 104 is shown in a perspective view.

The guide device 104 comprises a guide element 120, which is preferably made of a metal. The guide element 120 comprises two guide regions 122 at a distance from one another, in which the rechargeable battery pack 300 is in particular guidable by means of the adapter elements 308, 308a, 309, 309a. It is also conceivable that the guide element comprise several guide regions, or only a single guide region.

The guide regions 122 have a substantially identical design and comprise two opposing guide rails 124 designed to match the guide grooves of the guide unit 306 of the rechargeable battery pack 300. Alternatively, it would also be conceivable for the guide regions 122 to have different designs. Advantageously, construction space, in particular construction height, can be saved as a result.

The guide apparatus 104 comprises, e.g., two fastening units 126 designed to secure the connecting device 100, in particular the guide apparatus 104, to the frame 18 of the electric bicycle 14. The fastening units 126 are preferably arranged in the guide regions 122. The fastening units 126 are, e.g., designed for fastening via a screw connection. The mounting units 126 are, e.g., designed to enable a screw connection on both sides. In FIG. 7, an example of a fitting from the inside is shown by means of a respective screw 128, which is provided for connection to a thread (not shown) in the frame 18 of the electric bicycle 14. The mounting units 126 comprise a round hole 127, through which tolerance compensation is possible.

Alternatively, it is also conceivable that, as shown in FIG. 7b, the fastening unit 126 comprise a thread 130, e.g., in the form of a square nut, and be connected to the guide element 120. This is done, e.g., by retaining element 132, which is connected to the guide element 120 via two interlocking elements 134, wherein the thread 130 is clamped between the guide element 120 and the retaining element 132. Advantageously, a screw connection from the outside can also be achieved as a result.

The mounting module 107 is made of a plastic and connected to the metallic guide element 120 via a screw connection (not shown).

The mounting module 107 comprises mounting elements 134, 136, 138, 140 designed to connect the guide device 104, in particular the mounting module 107, to the locking device 102.

The mounting module 107 comprises a first mounting element 134, which is, e.g., designed as a rigid hook and is, e.g., arranged at the corners of the mounting module.

The mounting module 107 further comprises a second mounting element 136 which is designed as, e.g., a guide bar. The guide bar extends in this case along a longitudinal extension of the guide device 104. The mounting module 107 comprises a base 109. The guide bar is arranged on the base and is designed as a protrusion therein.

In addition, the mounting module 107 comprises a third mounting element 138, which is, e.g., designed as a resilient locking arm. The mounting module 107 comprises two locking arms inset in the base 109.

Acting as the fourth mounting element 140, the mounting module 107 comprises a transverse bar that, e.g., intersects the guide bar and limits relative movement of the locking device 102 in at least one direction.

The mounting module is, e.g., designed to be integral, and all of the mounting elements 134, 136, 138, 140 are also designed to be integral with the mounting module 107.

In FIG. 8a, the locking device 102 is shown in a perspective view. The locking device 102 shown in FIG. 8 is provided for connecting a rechargeable battery pack in a horizontal and/or vertical orientation.

The locking device 102, particularly the housing 106 of the locking device 102, comprises a first side 142 and a second side 144.

In a first configuration 143, the locking device 102 is connected to the guide device 104, in particular the mounting module 107 of the guide device 104, via the first side 142. In a second configuration 145, the locking device 102 is connected to the mounting module 107 via the second side 144.

The first side 142 is substantially flat. The first side 142 is designed to be integral with the first housing portion 108 of the housing 106 of the locking device 102.

The first side 142 in this case comprises, e.g., four first linkage elements 146, which are designed as recesses. Said recesses are designed to in particular receive an interlocking connection to the first mounting elements 134 of the mounting module 107.

In addition, the first side 142 comprises, e.g., a second linkage element 148 designed as, e.g., a guide groove. The guide groove is in this case designed to be inset in the first side 142. The second connecting element 148 on the first side 142 is in this case designed to connect and guide the second mounting element 136 of the mounting module 107. The guide bar of the mounting module 107 is thus guided within the guide groove of the locking device 102 during the connection process.

The first side 142 further comprises two third linkage elements 150 designed as recesses in the first side 142. The third first side connecting element 150 on the first side 142 is in this case designed to connect and receive the third mounting element 138 of the mounting module 107. In particular, the third linkage element 148 forms a rear section into which the resilient arms of the mounting module 107 snap into a final position.

The first side 142 further comprises a fourth connecting element 152 designed as a stop or a wall. The fourth connecting element 152 of the first side 142 is in this case designed to connect the fourth mounting element 140 of the mounting module 107. In particular, movement of the mounting module 107 is limited by a stop of the transverse bar on the wall.

As a result, the mounting module 107 is connected to the locking device 102 via a latching connection at the end of the connection process.

The first configuration 143 is preferably used for a vertical orientation of the rechargeable battery pack 300. The second configuration 145 is preferably used for a horizontal orientation of the rechargeable battery pack 300.

The second side 144 is provided for the second configuration 145, which is in particular used for horizontally aligned rechargeable battery packs 300.

The second side 144 is formed by the first housing portion 108 and the second housing portion 110. Additionally, in the exemplary configuration shown, the second side 144 is formed by an adapter housing 154 for a lock assembly 172 connected to the housing 106 in a frictional and/or interlocking manner, in particular to the second housing portion 110.

The second side comprises four connecting elements 156, 158, 160, 162 designed to be substantially identical to the four connecting elements 146, 148, 150, 152.

The second side 144 comprises four first linkage elements 156, wherein three first linkage elements 156 are arranged in the second housing portion 110 and a first linkage element 156 is arranged in the adapter housing 154.

The second side 144 comprises a second linkage element 158 in the form of a guide groove, wherein the second linkage element 158 is formed by the second housing portion 110 and the adapter housing 154.

The second side 144 also comprises two third connecting elements 160 designed as recesses, wherein the recesses are bordered or formed by the second housing portion 110 and the adapter housing 154.

The second side 144 further comprises a fourth connecting element 162 in the form of a wall formed in the second housing portion 110.

The first side 142 and the second side 144 have a common edge 164. The first side 142 and the second side 144, and thus also their connecting elements, are arranged to be offset at an angle of 90° to each other.

Also shown in FIG. 8a is another or third connector 163 of the plug unit 114 of the locking device 102. The further connector 163 is provided for electrically contacting the plug 314 of the rechargeable battery pack 300. The connector 163 comprises four electrical contact elements 166. Two electrical contact elements 166 are in this case used as power contacts 168 for energy transfer, and two electrical contact elements 166 are used as signal contacts 170 for the transmission of signals and/or data or information.

In FIG. 8b, a lock assembly 172 is inserted instead of the adapter housing 154. The lock assembly 172 can be connected directly to the housing 106 of the lock device 102, or via the adapter housing 154 to the lock device 102, as shown in FIG. 8b. It is also conceivable that the locking device 102 not comprise a lock assembly 172. The lock assembly 172 is, e.g., designed as a mechanical lock 174. The lock unit 172 comprises a first operating region 173 via which the lock unit 172 is in particular designed to be manually actuatable. The first operating region 173 is, e.g., designed as a key receptacle 176. The lock unit 172 is arranged in a recess (not shown) of the frame 18 in the state connected to the electric bicycle 14 such that the first operating region 173 is actuatable from the outside.

The housing 106 of the locking device 102 comprises a receptacle 178 designed to receive the rechargeable battery pack 300 when connected. The receptacle 178 is associated with the rechargeable battery pack interface 118 of the locking device 102.

In FIGS. 9a-b, the locking mechanism of the locking device 102 is shown at the beginning of the connection process for a horizontally-mounted rechargeable battery pack 300 in a sectional view (FIG. 9a) and in a perspective view (FIG. 9b).

The locking device 102 comprises a locking element 180 rotatably supported about a locking axis 182. The locking element 180 is partially arranged within the receptacle 178 of the locking device 102.

The locking element 180 is connected to a first reset element 184, which is, e.g., designed as a leg spring. The reset element 184 is directly connected to the locking element 180 by engaging the leg spring with an arm in a receptacle 186 of the locking element 180. A second arm of the leg spring is connected to the housing 106 of the locking device 102. The first reset element 184 applies a force to the locking element 180 counter to the connecting direction 188 of the rechargeable battery pack 300. In the unconnected state, the locking element 180 borders a stop 190, which limits movement of the locking element 180 counter to the connecting direction 188. The stop 190 is designed to be integral within the second housing portion 110.

The locking element 180 further comprises an actuation region 192. The actuation region 192 is designed such that the locking element 180 in the actuation region 192 is actuatable by the rechargeable battery pack 300, in particular by the connecting element 322 of the rechargeable battery pack 300. The actuation region 192 is arranged entirely within the receptacle 178 of the locking device 102. The actuation region 192 is, e.g., designed as a flat surface 193 extending substantially perpendicular to the connecting direction 188 in the unconnected state. The locking element 180 has a thickness in the actuation region 192 that does not exceed the length of the connecting element 322.

The locking device 102 also comprises a blocking element 194. The blocking element 194 is supported to be rotatably movable in the housing 106 of the locking device 102 about a blocking axis 196. The blocking axis 196 and the locking axis 182 are arranged parallel to each other.

The blocking element 194 comprises a blocking arm 198 arranged within the receptacle 178 of the locking device 102. The receptacle 178 has a shape that preferably substantially corresponds to the shape of the connecting unit 320 of the rechargeable battery pack 300.

The blocking element 194 is connected to a second reset element 200. The second reset element 200 is exemplarily designed as a leg spring directly connected to the housing 106, particularly the first housing portion 108, and to the blocking element 194. The second reset element 200 is in particular designed to apply a force to the blocking element 194 in the direction of the locking element 180. The blocking arm 198 is designed to be pushed completely out of the receptacle 178, in particular contrary to the spring force of the second reset element 200.

The blocking element 194 further comprises two points of application 202, 204, at which the blocking element 194 is actuatable independent of the rechargeable battery pack 300 and independent of the locking element 180.

The first point of application 202 is formed near a recess 205 in the housing 106 of the locking device. The frame 18 of the electric bicycle 14 comprises a corresponding opening adjacent the recess 205.

Actuation of the first point of application 202 can take place, e.g., via a tool in the form of a thin pin, which passes through the opening in the frame 18 and the recess 205 and actuates the blocking element 194 contrary to the spring force of the second reset element 200. Therefore, the locking device 102 comprises a second operating region 203 via which the fixation of the rechargeable battery pack 300 is releasable. The second operating region 203 is in this case arranged to be offset at angle of 90° from the first operating region 173.

The second point of application 204 is arranged on a side of the blocking element 194 opposite the first point of application 202. The second point of application 204 is thus not designed to be accessible from the outside. The second point of application 204 is designed to be actuatable via a release element 206. The release element 206 is supported to be rotatably movable about a release axis of 208 in the housing 106 of the locking device 102. The release axis 208 is in this case designed to be parallel to the blocking axis 196 and the locking axis 182.

The release element 206 is mechanically connected to the lock unit 172. By actuating the lock unit 172, a movement is transmitted to the release element 206, which then applies a force to the blocking element 194 at the second point of application 204 in order to move the blocking element 194 contrary to the spring force.

The lock unit 172 is not connected directly to or with a separate reset element. The lock unit 172 or release element 206 is reset to the home position by the second reset element 200 in the unactuated state.

In FIG. 9c, the locking mechanism of the locking device 102 for a horizontally-mounted rechargeable battery pack 300 in the fixed state is shown.

To move from the initial position shown in FIG. 9a to the fixed state shown in FIG. 9c, the rechargeable battery pack 300 is pushed by the connecting element 322 into the receptacle 178. In this case, the connecting element 322 initially borders the actuation region 192. The locking element 180 is then moved into the receptacle 178, or rather moved along with the rechargeable battery pack 300 into the receptacle, in the connecting direction 188 contrary to a first force (the force of the first reset element 184). At one point during this movement, the locking element 180 comes into contact with the blocking element 194, in particular the blocking arm 198 of the blocking element 194. In order to fix the rechargeable battery pack 300, the rechargeable battery pack 300 must starting at this point be moved contrary to a second force (the force of the first and second reset elements 184, 200). The locking element 180 and the blocking element 194 are rotated in the opposite direction, and the blocking element 194, in particular the blocking arm 198, is moved out of the receptacle 178.

The locking element 180 is shaped such that, during the connection process, the connecting element 322 of the rechargeable battery pack 300 is transferred or rolled from the actuation region 192 to a fixation region 210. The fixation region 210 is preferably adapted to the shape of the locking element 180 such that the locking element 180 is arranged within or enclosed by the fixation region 210 in the fixed state, substantially without clearance. The fixation region 210 is, e.g., designed as a circular recess. In addition, it is conceivable that one of the housing parts comprise a damping means, in particular a buffer, e.g. made of rubber, which is arranged contrary to the connecting direction 188. The damping means is preferably designed such that an additional force acts contrary to the connecting direction 188 and pushes the battery against the locking element 180 in the blocked state.

The actuation region 192 of the locking element 180 is designed to be integral with an arm 212 of the locking element 180, wherein the arm 212 is shaped such that the blocking arm 198 of the blocking element 194 snaps back into the receptacle 178 after it is pushed out of the receptacle 178 by the spring force of the second reset element 200 and locks or fixes the rechargeable battery pack 300 (see FIG. 9).

In the fixed state, the connecting element 322 of the rechargeable battery pack 300 is arranged entirely within the fixation region 210. The actuation region 192 of the locking element 180 borders an undercut on the blocking arm 198 of the blocking element 194.

The undercut is designed such that the connection cannot be released by pulling the rechargeable battery pack 300 counter to the connecting direction 188.

Actuation or disengagement of the blocking element 194 is necessary to then release the rechargeable battery pack 300. This can be accomplished by actuation of the blocking element 194 via the first operating region 173 or the second operating region 203.

By actuating the blocking element 194, the rear section is released, and the rechargeable battery pack 300 is then ejected by the locking element 180 due to the force of the first reset element 184 (see FIG. 9d).

An ejection distance in this case corresponds to a distance that the locking element 180 traverses counter to the connecting direction 188 as far as the stop 190.

The second reset element 200 is further designed such that the release element 206 is also returned to the home position, so connection to the rechargeable battery pack 300 is again possible.

In FIGS. 10 a-b, the locking mechanism of the locking device is shown at the beginning of the connection process for a vertically-mounted rechargeable battery pack 300, in a sectional view (FIG. 10a) and in a perspective view (FIG. 10b).

The connecting device 100 is in particular modular in that the first operating region 173 of the locking device 102 is always laterally arrangeable on the frame 18 of the electric bicycle 14.

To be able to use the same lock unit 172, the lock unit 172 is in this case connected to the housing 106 of the locking device 102 via the adapter housing 154.

Given the different orientation of the release element 206 connected to the adapter housing 154, the release axis 208 extends in a skewed manner, in particular offset by 90° to the blocking axis 196 and the locking axis 182.

The connection process and unlocking process via the second operating region 203 are thus substantially the same, but the unlocking process via actuation of the first operating region 173 is different.

The second point of application 204 of the blocking element 194 is not directly actuatable by the release element 206 in this configuration. Actuation occurs via a third point of application 214. The third point of application 214 is arranged above the first and second points of application 202, 204, and thus on a different plane.

The third point of application 214 is arranged on a cylindrical pin 216 that is, e.g., connected to the blocking element 194 in an interlocking manner. However, it would also be conceivable for the cylindrical pin 216 to be designed to be integral with the blocking element 194.

The release element 206 is connected to a transfer element 218. In particular, the transfer element 218 partially encloses the release element 206. The transfer element 218 is connected to the release element 206 in a non-rotatable manner. The transfer element 218 further comprises a ramp 220 bordering the third point of application 214. The ramp 220 is designed such that rotational movement of the release element 206 into rotational movement of the blocking element 194 is performed contrary to the force of the second reset element 200.

To ensure a reset of the release element 206 or lock assembly 172, the release element 206 comprises a third reset element 222 in the form of a tension spring connected to the transfer element 218 and the housing 106 of the locking device 102.

1. A locking device for locking a rechargeable battery pack with a consumer, comprising:
a battery pack interface configured to releasably connect the locking device to the rechargeable battery pack along a connecting direction,
wherein the rechargeable battery pack interface has a receptacle,
wherein the rechargeable battery pack is at least partially arranged in the connected state, and has at least one movably mounted locking element, and
wherein the locking element is always movable in the unconnected state and/or is preloaded with a force counter to the connecting direction in the connected state.

2. The locking device according to claim 1, wherein the locking element is pivotally supported about a locking axis.

3. The locking device according to claim 1, wherein the locking element is configured to be acted upon by a force counter to the connecting direction by way of a first reset element.

4. The locking device according to claim 3, wherein the first reset element is directly connected to the locking element.

5. The locking device according to claim 1, wherein:
the locking device comprises a movably supported blocking element, and
the blocking element is designed to block the locking element in at least one state.

6. The locking device according to claim 5, wherein the blocking element is pivotally supported about a blocking axis.

7. The locking device according to claim 5, wherein the blocking element is configured to be acted upon by a force in the direction of the locking element by way of a second reset element.

8. The locking device according to claim 5, wherein:
the locking device comprises a movably supported release element,
the release element is designed to be manually actuatable, and
the release element is further designed to move the blocking element from a blocking position to a release position.

9. The locking device according to claim 8, wherein the blocking element is configured to be acted upon by a force by way of the second reset element such that the release element is moved to a home position in the unactuated state.

10. The locking device according to claim 8, wherein:
the first reset element is designed such that the locking element is moved to an unlocking position upon actuation of the release element, and
the rechargeable battery pack is configured to be pushed out of the receptacle in the unlocking position partly by the locking element.

11. The locking device according to claim 10, wherein the first reset element is designed such that the locking element is always moved to the same unlocking position.

12. The locking device according to claim 5, wherein:
the locking element comprises an actuation region, and
the actuation region can is configured to be acted upon by the rechargeable battery pack in the unlocked state and borders the blocking element in the locked state such that movement of the locking element is blocked in at least one direction.

13. The locking device according to claim 12, wherein:
the locking element comprises a fixation region,
the fixation region is arranged adjacent the actuation region, and
the locking element is designed such that the rechargeable battery pack is guidable from the actuation region to the fixation region during the connection process.

14. The locking device according to claim 8, wherein:
the first reset element is designed such that the locking element is moved to an unlocking position upon actuation of the release element, and
the rechargeable battery pack is configured to be pushed out of the receptacle in the unlocking position mostly by the locking element.
